(19) United States
(12) Patent Application Publication
(10) Pub. No.: US 2026/0362414 A1
(43) Pub. Date: Nov. 12, 2026

(54) Method, Device and Computer Program Product for Wireless Communication

(71) Applicant: ZTE CORPORATION, Shenzhen, Guangdong (CN)

(72) Inventors: Jianqiang DAI, Shenzhen (CN); Jun XU, Shenzhen (CN); Jiajun XU, Shenzhen (CN); Mengzhu CHEN, Shenzhen (CN)

(21) Appl. No.: 19/121,622

(22) PCT Filed: Oct. 18, 2022
(86) PCT No.: PCT/CN2022/126025

§ 371 Date: Apr. 16, 2025

(51) Int. Cl. H04W 72/1268; H04W 72/21

(52) U.S. Cl. CPC H04W 72/1268; H04W 72/21

(57) ABSTRACT

A wireless communication method is disclosed. The method comprises transmitting, by a wireless communication terminal to a wireless communication node, uplink traffic information; receiving, by the wireless communication terminal from the wireless communication node, uplink transmission indications periodically in response to the uplink traffic information; and transmitting, by the wireless communication terminal to the wireless communication node, an uplink message periodically according to the uplink transmission indications.

### TECHNICAL FIELD

This document is directed generally to wireless communications, and in particular to 5^{th} generation (5G) communications or 6^{th} generation (6G) communications.

### BACKGROUND

Uplink (UL) scheduling and downlink (DL) scheduling are used in the wireless communication system to transmit the UL and DL data. However, in some approaches, UL and DL scheduling may cause transmission latency. Accordingly, a method that allows the wireless communication system to have capability of high data rate and low network latency is desired.

### SUMMARY

This document relates to methods, devices and computer program products for UL transmissions.

One aspect of the present disclosure relates to a wireless communication method. In an embodiment, the wireless communication method includes: transmitting, by a wireless communication terminal to a wireless communication node, uplink traffic information; receiving, by the wireless communication terminal from the wireless communication node, uplink transmission indications periodically in response to the uplink traffic information; and transmitting, by the wireless communication terminal to the wireless communication node, an uplink message periodically according to the uplink transmission indications.

Another aspect of the present disclosure relates to a wireless communication method. In an embodiment, the wireless communication method includes: receiving, by a wireless communication node from a wireless communication terminal, uplink traffic information; and transmitting, by the wireless communication terminal to the wireless communication node, uplink transmission indications periodically in response to the uplink traffic information to allow the wireless communication terminal to transmit an uplink message periodically according to the uplink transmission indications.

Another aspect of the present disclosure relates to a wireless communication terminal. In an embodiment, the wireless communication terminal includes a communication unit and a processor. The processor is configured to: transmit, to a wireless communication node, uplink traffic information; receive, from the wireless communication node, uplink transmission indications periodically in response to the uplink traffic information; and transmit, to the wireless communication node, an uplink message periodically according to the uplink transmission indications.

Another aspect of the present disclosure relates to a wireless communication node. In an embodiment, the wireless communication node includes a communication unit and a processor. The processor is configured to: receive, from a wireless communication terminal, uplink traffic information; and transmit, to the wireless communication node, uplink transmission indications periodically in response to the uplink traffic information to allow the wireless communication terminal to transmit an uplink message periodically according to the uplink transmission indications.

Various embodiments may preferably implement the following features:

Preferably, the P-CSCF address request indication is carried in a Protocol Configuration Options, PCO, information element, IE.

Preferably, the uplink traffic information comprises at least one of: a packet size of periodic packets or bursts to be transmitted to the wireless communication node, a period of the periodic packets or bursts to be transmitted to the wireless communication node, a recommended Transport Block Size, TBS, a recommended resource size, a recommended number of physical uplink shared channel, PUSCH, occasions, or a recommended period for the uplink transmission indications.

Preferably, the packet size of the periodic packets or bursts comprises at least one of: a minimum size of the periodic packets or bursts, a minimum size of payloads in the periodic packets or bursts, a medium size of the periodic packets or bursts, a medium size of payloads in the periodic packets or bursts, an average size of the periodic packets or bursts, or an average size of payloads in the periodic packets or bursts.

Preferably, the uplink traffic information comprises at least one of:
a time instant or slot of periodic packets or bursts to be transmitted generated by the wireless communication terminal,
a deadline time instant or slot for a frame refreshing for the periodic packets or bursts,
packet segmentation information for the periodic packets or bursts, or burst boundary information, or Protocol Data Unit, PDU, set boundary information,
a packet deadline budget, PDB, for a packet or a flow of the periodic packets or bursts,
resource or PUSCH occasion occupied information or resource releasing information, or
a configured grant, CG, index corresponding to the periodic packets or bursts.

Preferably, the uplink traffic information is carried by at least one of: Medium Access Control Control Element, MAC CE, signaling, Radio Resource Control, RRC, signaling, or a first physical uplink shared channel, PUSCH.

Preferably, the first PUSCH is scheduled by a first uplink grant in the uplink transmission indications.

Preferably, the first PUSCH is a first one of CG PUSCHs in a period for transmitting the uplink message.

Preferably, one of the uplink transmission indications comprises at least one of: a first uplink grant indicating a transmission of a buffer status report, BSR, and the uplink data; or an indication for activating or deactivating a pre-configured CG configuration for a transmission of a buffer status report, BSR, and the uplink data.

Preferably, a connected mode discontinuous reception, CDRX, is configured to the wireless communication terminal with a period aligned with a period of monitoring occasions for the uplink transmission indications.

Preferably, the wireless communication terminal monitors a physical downlink control channel, PDCCH, for the uplink transmission indications in monitoring occasions for the uplink transmission indications and refrains from monitoring the PDCCH for the uplink transmission indications beyond the monitoring occasions for the uplink transmission indications.

Preferably, the wireless communication terminal monitors a PDCCH for the uplink transmission indications in first parts of monitoring occasions for the uplink transmission indications and refrains from monitoring the PDCCH for the uplink transmission indications in second parts the monitoring occasions for the uplink transmission indications.

Preferably, the wireless communication terminal skips monitoring a PDCCH for the uplink transmission indications in response to a buffer for the uplink data is empty or the wireless communication terminal has no data to be transmitted to the wireless communication node.

Preferably, the wireless communication terminal transmits an indication to the wireless communication node to stop the uplink transmission indications or release a resource for the uplink data.

Preferably, a period of monitoring occasions for the uplink transmission indications is aligned with one or more times of a period of periodic packets or bursts to be transmitted the wireless communication node.

Preferably, a start of monitoring occasions for the uplink transmission indications is different from a start of different monitoring occasions transmission indications for a different wireless communication terminal monitoring a PDCCH.

Preferably, the wireless communication terminal receives a second uplink grant in associated with at least one of the BSR, the first uplink grant, or information transmitted from the wireless communication terminal to the wireless communication node.

Preferably, the wireless communication terminal transmits a part of a packet or burst to be transmitted to the wireless communication terminal according to the first uplink grant and transmits a remaining part of the packet to the wireless communication terminal according to the second uplink grant.

Preferably, a configuration of the first uplink grant is modified according to the second uplink grant.

Preferably, a number of bit fields of the second uplink grant is less than a number of bit fields of the first uplink grant.

Preferably, the wireless communication node receives an indication from the wireless communication terminal for stopping the uplink transmission indications or releasing a resource for the uplink data.

Preferably, the wireless communication node transmits a second uplink grant to the wireless communication terminal according to at least one of the BSR, the first uplink grant, or information received from the wireless communication terminal.

Preferably, the first uplink grant is for a part of a packet or burst to be transmitted the second uplink grant is for a remaining part of the packet or burst.

Preferably, the wireless communication node modifies a configuration of the first uplink grant according to the second uplink grant.

The present disclosure relates to a computer program product comprising a computer-readable program medium code stored thereupon, the code, when executed by a processor, causing the processor to implement a wireless communication method recited in any one of foregoing methods.

### BRIEF DESCRIPTION OF THE DRAWINGS

The exemplary embodiments disclosed herein are directed to providing features that will become readily apparent by reference to the following description when taken in conjunction with the accompany drawings. In accordance with various embodiments, exemplary systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the exemplary embodiments and applications described and illustrated herein. Additionally, the specific order and/or hierarchy of steps in the methods disclosed herein are merely exemplary approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

The above and other aspects and their implementations are described in greater detail in the drawings, the descriptions, and the claims.

FIG. 1 shows a schematic diagram of a transmission of uplink data according to an embodiment of the present disclosure.

FIG. 2 shows a schematic diagram of a transmission of uplink data according to an embodiment of the present disclosure.

FIG. 3 shows a schematic diagram of a transmission of uplink data according to an embodiment of the present disclosure.

FIG. 4 shows an example of a schematic diagram of a wireless communication terminal according to an embodiment of the present disclosure.

FIG. 5 shows an example of a schematic diagram of a wireless communication node according to an embodiment of the present disclosure.

FIG. 6 shows a flowchart diagram of a method according to an embodiment of the present disclosure.

FIG. 7 shows a flowchart diagram of a method according to an embodiment of the present disclosure.

### DETAILED DESCRIPTION OF THE EMBODIMENTS

In some applications (e.g., extended Reality (XR) applications), a network needs to have the capabilities of high data rate and low network latency.

Typically, extended Reality denotes Augmented Reality (AR), Mixed Reality (MR), and/or Virtual Reality (VR). The technology of XR may combine the real world and the virtual information generated by digital devices, so as to enable users to perceive immersive experience in a mixed real-virtual environment.

In some embodiments, methods improving the system capacity may be adopted. For example, the dynamic grant may be enhanced by simplifying the procedures of SR (scheduling request) transmission and/or BSR (buffer status report) transmission.

In some embodiments, to handle UL packets or bursts (e.g., XR packets or bursts (e.g., packets or bursts for the XR service)) to be transmitted to a gNB (gNodeB) which arrive periodically and have varied payload sizes, a pre-configured PUSCH (physical uplink shared channel) resource as well as subsequent dynamically allocated PUSCH resources may be used. In some embodiments, for transmitting UL bursts, a periodic UL grant as well as subsequent dynamically allocated PUSCH resources may be used.

In some embodiments, the pre-configured PUSCH resource may be determined or indicated by using the configured grant (CG) mechanism, or by using a periodic DL (downlink) scheduling mechanism (e.g., the UL grant).

With the configurations mentioned above, the capability of the communication terminal and the network can be improved.

In some embodiments, to handle periodic traffics with varied payload size in each period, a dynamic grant enhancement may be adapted to simplify the procedure of SR (Scheduling request) transmission and/or BSR (Buffer status report) transmission. Details in this regard will be described below.

In some embodiments, to handle periodic traffics with varied payload size in each period, a pre-configured PUSCH (Physical Uplink Shared Channel) resource as well as subsequent dynamically allocated PUSCH resource may be used.

Through the configuration in some embodiments of the present disclosure, the scheduling delay of the dynamic grant caused by SR and/or BSR transmission can be reduced. Besides, the capacity gain can be obtained through resource (pre-)allocations.

Besides, through the configuration in some embodiments of the present disclosure, the energy consumption of the UE may be decreased by reducing PDCCH (physical downlink control channel) monitoring.

In some embodiments, to handle periodic traffics, a method is provided, which comprises: transmitting, by a wireless communication terminal (e.g., a UE (user equipment)) to a wireless communication node (e.g., a gNB (gNodeB)), uplink traffic information; receiving, by the wireless communication terminal from the wireless communication node, uplink transmission indications periodically in response to the uplink traffic information; and transmitting, by the wireless communication terminal to the wireless communication node, an uplink message periodically according to the uplink transmission indications.

In some embodiments, the uplink traffic information may include long-term information. In some embodiments, the uplink traffic information may include at least one of: a packet size of periodic packets or bursts to be transmitted to the wireless communication node, a period of the periodic packets or bursts to be transmitted to the wireless communication node, a recommended Transport Block Size, TBS, a recommended resource size, a recommended number of physical uplink shared channel, PUSCH, occasions, or a recommended period for the uplink transmission indications. In some embodiments, the long-term information may be carried by RRC signaling.

In some embodiments, the uplink traffic information may include XR traffic information, but is not limited in this regards. In some embodiments, the periodic packets or bursts to be transmitted to the wireless communication node may be XR packets or bursts, but is not limited in this regards.

In some embodiments, the packet size of periodic packets or bursts may include at least one of: a minimum size of the periodic packets or bursts, a minimum size of payloads in the periodic packets or bursts, a medium size of the periodic packets or bursts, a medium size of payloads in the periodic packets or bursts, an average size of the periodic packets or bursts, or an average size of payloads in the periodic packets or bursts.

In some embodiments, the uplink traffic information may include short-term information. In some embodiments, the uplink traffic information may include at least one of:
a time instant or slot of periodic packets or bursts to be transmitted generated by the wireless communication terminal,
a deadline time instant or slot for a frame refreshing for the periodic packets or bursts,
packet segmentation information for the periodic packets or bursts, or burst boundary information, or Protocol Data Unit, PDU, set boundary information,
a packet deadline budget, PDB, for a packet or a flow of the periodic packets or bursts,
resource or PUSCH occasion occupied information or resource releasing information, or
a configured grant, CG, index corresponding to the periodic packets or bursts.

In some embodiments, the short-term information may be carried by DCI signaling.

In some embodiments, the uplink transmission indications may include at least one of: a first uplink grant indicating a transmission of an uplink message or an indication for activating or deactivating a pre-configured CG configuration for the uplink message. In some embodiments, the uplink message may comprise at least one of a BSR of the uplink buffer of the wireless communication terminal or uplink data. That is, the uplink transmission indications may include at least one of: first uplink grant indicating a transmission of a BSR and uplink data; or an indication for activating or deactivating a pre-configured CG configuration for a transmission of a BSR and uplink data.

In some embodiments, the wireless communication node may determine the uplink transmission indications according to the uplink traffic information provided by the wireless communication terminal.

Details of the embodiments will be provided in the paragraphs below, but the present disclosure is not limited thereto.

### Embodiment 1: UE Sends Assistance Information to gNB

### Case 1-1, UE Recommends Long-Term Traffic Information

In some embodiments, the UE may transmit traffic information to the gNB for scheduling. In some embodiments, the UE may generate packets or bursts for a certain service or application (e.g., an XR service or application) to be transmitted to the gNB. In some embodiments, the UE may periodically generate the packets or bursts for a certain service or application (e.g., an XR service or application) to be transmitted to the gNB. In some embodiments, the packets or bursts are periodic packets or bursts. In some embodiments, the UE may transmit at least one of a packet size of the packets or bursts or a period of the periodic packets or bursts to the gNB for scheduling.

In some embodiments, the packet size may include, for example, a minimum, medium, or average size of the packets or bursts, or a minimum, medium, or average size of the payloads in the packets or bursts.

In some embodiments, for UL (uplink) AR (augmented reality) video, the period of the packets or bursts is assumed, and the packet sizes of the packets or bursts may be large and variable. In some embodiments, the UE can provide the traffic information to the gNB, and the traffic information can be a long-term value or a statistic value of the traffic of a certain service (e.g., the XR service).

In some embodiments, according to the traffic information provided from the UE, the gNB can perform scheduling. For example, the gNB may send a first UL grant according to the periodicity information, or adjust the scheduling priority or allocated flexible resource in the first UL grant. In some embodiments, the first UL grant may indicate the resource for the UE to transmit a packet or burst or a part of a packet or burst.

### Case 1-1-a

In some embodiments, the UE may transmit the traffic information to the gNB, including at least one of: a recommended TBS (Transport Block Size), a recommended resource size, or a period of the periodic packets or bursts, or a recommended number of physical uplink shared channel, PUSCH, occasions.

### Case 1-2, UE Sends Dynamic/Short-Term Information

In some embodiments, the UE may send dynamic or short-term information to the gNB.

In some embodiments, the dynamic or short-term information may include at least one of assistance information or control information for the link or resource adaption.

In some embodiments, the dynamic or short-term information may include at least one of:
a packet generated/arrival time instant or slot at the UE side,
a deadline time instant or slot for the frame refreshing for the packets or bursts,
packet segmentation information (e.g., a number of segmentations of the packet(s) from the UE), or burst boundary information, or PDU set boundary information (for the multiple flow transmission, the packet segmentation information, burst boundary information, or PDU set boundary information and a corresponding PDB (packet deadline budget) for each packet or flow are sent to the gNB),
resource occupied or release information (e.g., when the first UL grant schedules multiple PUSCHs, or multiple PUSCHs are configured in a CG PUSCHs period, the UE may indicate the occupied resource and non-occupied resource which can be released), or
a CG (configured grant) configuration index, e.g., the UE selects a CG configuration index according to the UL traffic (e.g., XR UL traffic).

In some embodiments, the dynamic or short-term information may be transmitted to the gNB via a MAC CE (Medium Access Control Control Element), UCI (Uplink Control Information), or the first PUSCH.

In some embodiments, the first PUSCH is a PUSCH scheduled by the first UL grant, In some embodiments, the first PUSCH is the first one of CG PUSCHs in a period for transmitting the uplink message.

### Embodiment 2: Configuration of Period of PDCCH, and Corresponding UE Power Saving Solutions

Configuration of pre-defined/first UL grant:

In some embodiments, the first UL grants are periodic, and the gNB determines the periodicity of first UL grants.

In some embodiments, the gNB determines the resources allocated by the first UL grants.

Case 2-1: UE monitors PDCCHs in periodic PDCCH monitoring occasions.

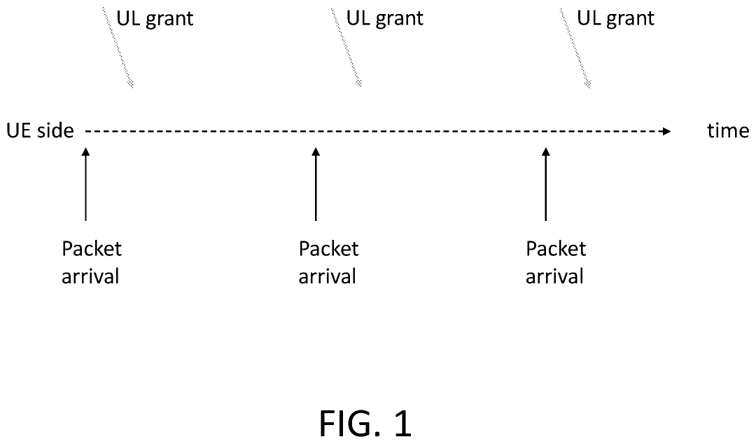

In some embodiments, the UE may monitor PDCCHs (physical downlink control channels) for obtaining the first UL grant in periodic PDCCH monitoring occasions. As shown in FIG. 1, the UE have periodic packets or bursts generated or arrived. The UE receives the PDCCHs for the first UL grants. Upon receiving a first UL grant, the UE transmits a BSR and UL data (e.g., at least a part) to the gNB according to the received first UL grant. In some embodiments, the period of the first UL grants and the period of the generated/arrived periodic packets or bursts are identical. In some embodiments, the period of the first UL grants and the period of the PDCCH monitoring occasions are identical.

In some embodiments, the UE may adopt a power saving configuration include at least one of:
1) the CDRX (connected mode DRX (Extended Discontinuous Reception)) being configured according to the period, i.e., the periodicity of the CDRX and the periodicity of the PDCCH monitoring occasions being aligned;
2) the UE monitoring the PDCCH (either a DL grant or a UL grant) in a first part of a PDCCH monitoring occasion, and refraining from monitoring the PDCCH in a first part of a PDCCH monitoring occasion (e.g., according to the dynamic or short-term information, the UE knows there is a delay for a first UL grant, and determines to monitoring the PDCCH in the later part of the corresponding PDCCH monitoring occasion);
3) if the UE receives the PDCCH (e.g., the UL grant) but the buffer is empty or there is no data to be transmitted, the UE skipping the PDCCH monitoring. In an embodiment, UE transmits an indication to the gNB to stop the first UL grant transmission. In an embodiment, UE transmits an indication to the gNB to release a resource; and/or
4) the UE monitoring the PDCCH at fixed PDCCH monitoring occasions.

In some embodiments, the periodicity of the PDDCH monitoring occasions is aligned with a periodicity of the UL traffic (e.g., the packets or bursts generated by the UE to be transmitted to the gNB).

### Case 2-2: Periodic Activation or Deactivation Indications

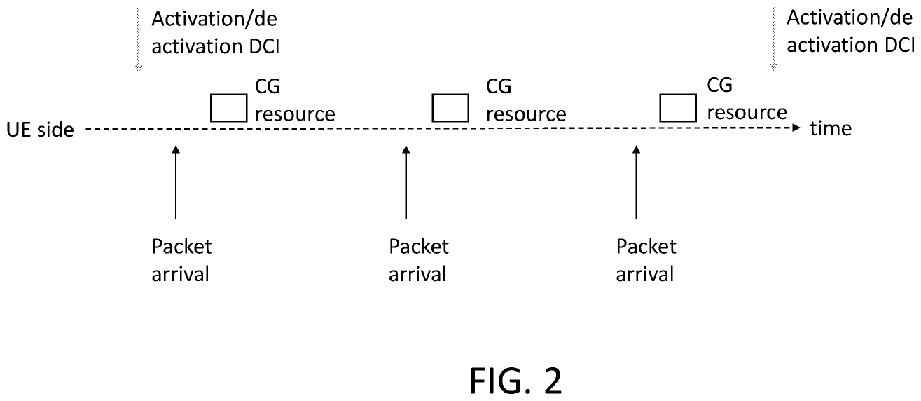

In some embodiments, the gNB may transmit an activation or deactivation indication to the UE for activating or deactivating a pre-configured CG configuration for the BSR and/or uplink data (see FIG. 2). According to the activation indication, the UE may transmit the BSR and/or uplink data to the gNB on the resource indicated by the pre-configured CG configuration. According to the deactivation indication, the UE may stop transmitting the BSR and/or uplink data to the gNB.

In some embodiments, the UE transmits BSR and at least a part of a UL packet or burst at a corresponding pre-configured UL resource indicated by the pre-configured CG configuration.

In some embodiments, the parameters of the CG configuration (e.g., including the resource size) are pre-configured based on the UL traffic information.

In some embodiments, the UE may adopt a power saving configuration include at least one of:
1) the CDRX (connected mode DRX (Extended Discontinuous Reception)) being configured according to the period, i.e., the periodicity of the CDRX and the periodicity of the PDCCH monitoring occasions being aligned;
2) the UE monitoring the PDCCH (e.g., the indication of activating or deactivating the CG configuration) in a first part of a PDCCH monitoring occasion, and refraining from monitoring the PDCCH in a first part of a PDCCH monitoring occasion (e.g., according to the dynamic or short-term information, the UE knows there is a delay for an indication of activating or deactivating the CG configuration, and determines to monitoring the PDCCH in the later part of the corresponding PDCCH monitoring occasion);
3) if the UE receives the PDCCH (e.g., the indication of activating or deactivating the CG configuration) but the buffer is empty or there is no data to be transmitted, the UE skipping the PDCCH monitoring and/or transmitting an indication to the gNB to stop the indication of activating or deactivating the CG configuration or release a resource; In an embodiment, the UE transmits an indication to the gNB to release a CG resource; and/or
4) the UE monitoring the PDCCH at fixed PDCCH monitoring occasions (e.g., for the indication of activating or deactivating the CG configuration).

In some embodiments, the start of the PDCCH monitoring occasions may be configured. In some embodiments, the starts of the PDCCH monitoring occasions for different UEs are different.

In some embodiments, the periodicity of the PDDCH monitoring occasions is a number of times of the periodicity of the UL traffic (e.g., the packets or bursts generated by the UE to be transmitted to the gNB).

In some embodiments, the periodicity of the PDDCH monitoring occasions is aligned with the periodicity of the UL traffic (e.g., the packets or bursts generated by the UE to be transmitted to the gNB).

Embodiment 3: The Relationship Between the First UL Grant and the Second UL Grant

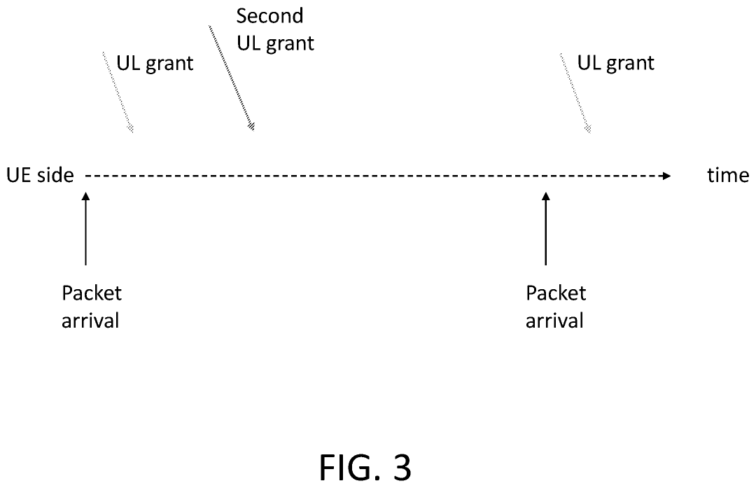

In some embodiments, after the UE receiving the first UL grant, the UE may send a BSR and uplink data (e.g., a part of an XR packet) according the first UL grant. According to at least one of the BSR, the first uplink grant, or information transmitted from the UE to the gNB, the gNB may transmit a second UL grant to the UE (see FIG. 3).

In some embodiments, the UE may receive the second UL grant, and transmit the remaining part of the UL packet or burst to the gNB according to the second UL. In this case, the second UL grant may be determined based on the BSR from the UE.

In some embodiments, there may be some relationships between the first UL grant and the second UL grant.

In some embodiments, the second UL grant can be determined based on the BSR and the first UL grant. In some embodiments, the second UL grant can be determined based on the BSR and the information transmitted from the UE to the gNB.

In some embodiments, the gNB may receive an amount of the remaining data of a UL packet or burst.

In some embodiments, the gNB may modify a configuration of the first uplink grants according to the second uplink grant. For example, a periodicity of the first uplink grant may be modified according to information in the second uplink grant.

In some embodiments, the second UL grant may be a reduced DCI. In some embodiments, some bit fields of second UL grant may be identical to the corresponding bit fields in first UL grant. In some embodiments, these bit fields of second UL grant may be omitted. In some embodiments, a number of bit fields of the second UL grant is less than a number of bit fields of the first UL grant.

In some embodiments, to handle periodic traffics, another method is provided, which comprises: receiving, by a wireless communication node from a wireless communication terminal, uplink traffic information; and transmitting, by the wireless communication terminal to the wireless communication node, uplink transmission indications periodically in response to the uplink traffic information to allow the wireless communication terminal to transmit an uplink message periodically according to the uplink transmission indications.

Details of the method can be ascertained by referring to the embodiments above, and will not be repeated herein.

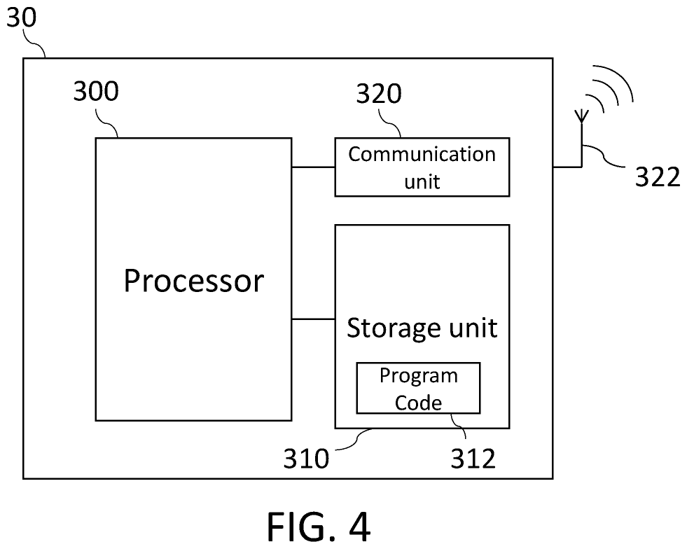

FIG. 4 relates to a diagram of a wireless communication terminal 30 according to an embodiment of the present disclosure. The wireless communication terminal 30 may be a tag, a mobile phone, a laptop, a tablet computer, an electronic book or a portable computer system and is not limited herein. The wireless communication terminal 30 may include a processor 300 such as a microprocessor or Application Specific Integrated Circuit (ASIC), a storage unit 310 and a communication unit 320. The storage unit 310 may be any data storage device that stores a program code 312, which is accessed and executed by the processor 300. Embodiments of the storage code 312 include but are not limited to a subscriber identity module (SIM), read-only memory (ROM), flash memory, random-access memory (RAM), hard-disk, and optical data storage device. The communication unit 320 may a transceiver and is used to transmit and receive signals (e.g., messages or packets) according to processing results of the processor 300. In an embodiment, the communication unit 320 transmits and receives the signals via at least one antenna 322.

In an embodiment, the storage unit 310 and the program code 312 may be omitted and the processor 300 may include a storage unit with stored program code.

The processor 300 may implement any one of the steps in exemplified embodiments on the wireless communication terminal 30, e.g., by executing the program code 312.

The communication unit 320 may be a transceiver. The communication unit 320 may as an alternative or in addition be combining a transmitting unit and a receiving unit configured to transmit and to receive, respectively, signals to and from a wireless communication node.

In some embodiments, the wireless communication terminal 30 may be used to perform the operations of the UE described above. In some embodiments, the processor 300 and the communication unit 320 collaboratively perform the operations described above. For example, the processor 300 performs operations and transmit or receive signals, message, and/or information through the communication unit 320.

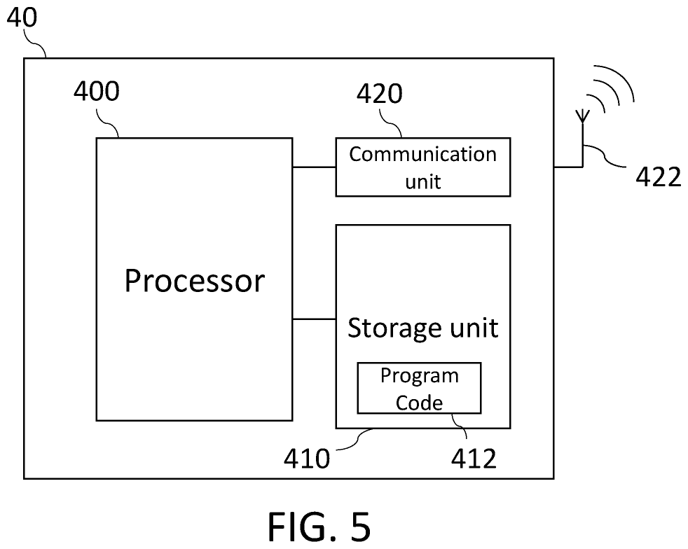

FIG. 5 relates to a diagram of a wireless communication node 40 (e.g., a session management node) according to an embodiment of the present disclosure. The wireless communication node 40 may be a satellite, a base station (BS), a gNB, a network entity, a Domain Name System (DNS) server, a Mobility Management Entity (MME), Serving Gateway (S-GW), Packet Data Network (PDN) Gateway (P-GW), a radio access network (RAN), a next generation RAN (NG-RAN), a data network, a core network, a communication node in the core network, or a Radio Network Controller (RNC), and is not limited herein. In addition, the wireless communication node 40 may include (perform) at least one network function such as an access and mobility management function (AMF), a session management function (SMF), a user place function (UPF), a policy control function (PCF), an application function (AF), etc. The wireless communication node 40 may include a processor 400 such as a microprocessor or ASIC, a storage unit 410 and a communication unit 420. The storage unit 410 may be any data storage device that stores a program code 412, which is accessed and executed by the processor 400. Examples of the storage unit 412 include but are not limited to a SIM, ROM, flash memory, RAM, hard-disk, and optical data storage device. The communication unit 420 may be a transceiver and is used to transmit and receive signals (e.g., messages or packets) according to processing results of the processor 400. In an example, the communication unit 420 transmits and receives the signals via at least one antenna 422.

In an embodiment, the storage unit 410 and the program code 412 may be omitted. The processor 400 may include a storage unit with stored program code.

The processor 400 may implement any steps described in exemplified embodiments on the wireless communication node 40, e.g., via executing the program code 412.

The communication unit 420 may be a transceiver. The communication unit 420 may as an alternative or in addition be combining a transmitting unit and a receiving unit configured to transmit and to receive, respectively, signals, messages, or information to and from a wireless communication node or a wireless communication terminal.

In some embodiments, the wireless communication node 40 may be used to perform the operations of the gNB described above. In some embodiments, the processor 400 and the communication unit 420 collaboratively perform the operations described above. For example, the processor 400 performs operations and transmit or receive signals through the communication unit 420.

A wireless communication method is also provided according to an embodiment of the present disclosure. In an embodiment, the wireless communication method may be performed by using a wireless communication terminal (e.g., a UE). In an embodiment, the wireless communication terminal may be implemented by using the wireless communication terminal 30 described above, but is not limited thereto.

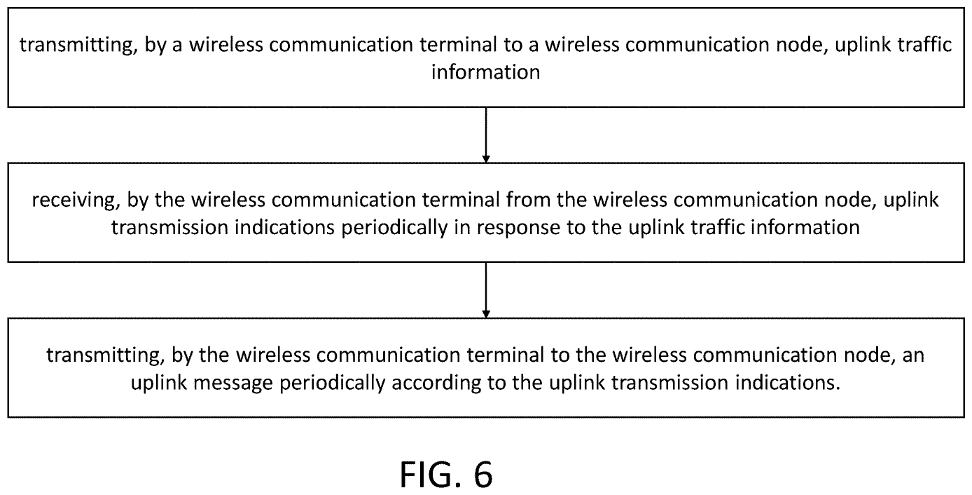

Referring to FIG. 6, in an embodiment, the wireless communication method includes: transmitting, by a wireless communication terminal to a wireless communication node, uplink traffic information; receiving, by the wireless communication terminal from the wireless communication node, uplink transmission indications periodically in response to the uplink traffic information; and transmitting, by the wireless communication terminal to the wireless communication node, an uplink message periodically according to the uplink transmission indications.

Details in this regard can be ascertained with reference to the paragraphs above, and will not be repeated herein.

Another wireless communication method is also provided according to an embodiment of the present disclosure. In an embodiment, the wireless communication method may be performed by using a wireless communication node (e.g., a gNB). In an embodiment, the wireless communication node may be implemented by using the wireless communication node 40 described above, but is not limited thereto.

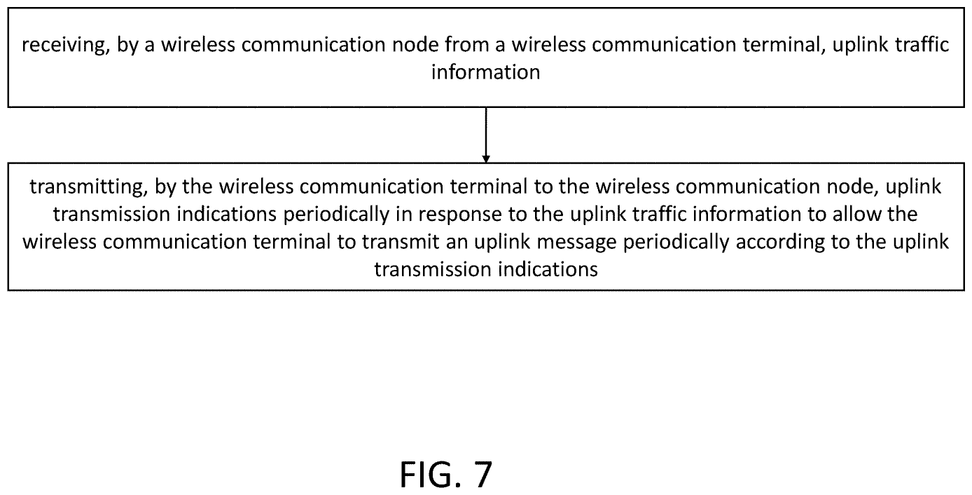

Referring to FIG. 7, in an embodiment, the wireless communication method includes receiving, by a wireless communication node from a wireless communication terminal, uplink traffic information; and transmitting, by the wireless communication terminal to the wireless communication node, uplink transmission indications periodically in response to the uplink traffic information to allow the wireless communication terminal to transmit an uplink message periodically according to the uplink transmission indications.

Details in this regard can be ascertained with reference to the paragraphs above, and will not be repeated herein.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand exemplary features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described exemplary embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium. communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of the claims. Thus, the disclosure is not intended to be limited to the implementations shown herein, but is to be accorded the widest scope consistent with the novel features and principles disclosed herein, as recited in the claims below.

1. A wireless communication method comprising:
transmitting, by a wireless communication terminal to a wireless communication node, uplink traffic information;
receiving, by the wireless communication terminal from the wireless communication node, uplink transmission indications periodically in response to the uplink traffic information; and
transmitting, by the wireless communication terminal to the wireless communication node, an uplink message periodically according to the uplink transmission indications.

2. The wireless communication method of claim 1, wherein the uplink traffic information comprises at least one of: a packet size of periodic packets or bursts to be transmitted to the wireless communication node, a period of the periodic packets or bursts to be transmitted to the wireless communication node, a recommended Transport Block Size, TBS, a recommended resource size, a recommended number of physical uplink shared channel, PUSCH, occasions, or a recommended period for the uplink transmission indications.

3. The wireless communication method of claim 2, wherein the packet size of the periodic packets or bursts comprises at least one of: a minimum size of the periodic packets or bursts, a minimum size of payloads in the periodic packets or bursts, a medium size of the periodic packets or bursts, a medium size of payloads in the periodic packets or bursts, an average size of the periodic packets or bursts, or an average size of payloads in the periodic packets or bursts.

4. The wireless communication method of claim 1, wherein the uplink traffic information comprises at least one of:
a time instant or slot of periodic packets or bursts to be transmitted generated by the wireless communication terminal,
a deadline time instant or slot for a frame refreshing for the periodic packets or bursts,
packet segmentation information for the periodic packets or bursts, or burst boundary information, or Protocol Data Unit, PDU, set boundary information,
a packet deadline budget, PDB, for a packet or a flow of the periodic packets or bursts,
resource or PUSCH occasion occupied information or resource releasing information, or
a configured grant, CG, index corresponding to the periodic packets or bursts.

5. The wireless communication method of claim 1 4, wherein the uplink traffic information is carried by at least one of: Medium Access Control Control Element, MAC CE, signaling, Radio Resource Control, RRC, signaling, or a first physical uplink shared channel, PUSCH.

6. The wireless communication method of claim 5, wherein the first PUSCH is scheduled by a first uplink grant in the uplink transmission indications.

7. The wireless communication method of claim wherein the first PUSCH is a first one of CG PUSCHs in a period for transmitting the uplink message.

8. The wireless communication method of claim 1, wherein one of the uplink transmission indications comprises at least one of: a first uplink grant indicating a transmission of a buffer status report, BSR, and uplink data; or an indication for activating or deactivating a pre-configured CG configuration for a transmission of a BSR and uplink data.

9. The wireless communication method of claim 8, wherein a connected mode discontinuous reception, CDRX, is configured to the wireless communication terminal with a period aligned with a period of monitoring occasions for the uplink transmission indications.

10. The wireless communication method of claim 8, wherein the wireless communication terminal monitors a physical downlink control channel, PDCCH, for the uplink transmission indications in monitoring occasions and refrains from monitoring the PDCCH for the uplink transmission indications beyond the monitoring occasions for the uplink transmission indications.

11. The wireless communication method of claim 8, wherein the wireless communication terminal monitors a PDCCH for the uplink transmission indications in first parts of monitoring occasions for the uplink transmission indications and refrains from monitoring the PDCCH for the uplink transmission indications in second parts the monitoring occasions for the uplink transmission indications.

12. The wireless communication method of claim 8, wherein the method comprises at least one of the following:
the wireless communication terminal skips monitoring a PDCCH for the uplink transmission indications in response to a buffer for the uplink data is empty or the wireless communication terminal has no data to be transmitted to the wireless communication node.:
the wireless communication terminal transmits an indication to the wireless communication node to stop the uplink transmission indications or release a resource for the uplink data:
a period of monitoring occasions for the uplink transmission indications is aligned with one or more times of a period of periodic packets or bursts to be transmitted the wireless communication node;
a start of monitoring occasions for the uplink transmission indications is different from a start of different monitoring occasions transmission indications for a different wireless communication terminal monitoring a PDCCH.

13. (canceled)

14. (canceled)

15. (canceled)

16. The wireless communication method of claim 8, wherein the wireless communication terminal receives a second uplink grant in associated with at least one of the BSR, the first uplink grant, or information transmitted from the wireless communication terminal to the wireless communication node.

17. The wireless communication method of claim 16, wherein the wireless communication terminal transmits a part of a packet or burst to be transmitted to the wireless communication node according to the first uplink grant and transmits a remaining part of the packet to the wireless communication node according to the second uplink grant.

18. The wireless communication method of claim 16, wherein a configuration of the first uplink grant is modified according to the second uplink grant.

19. The wireless communication method of claim 16, wherein a number of bit fields of the second uplink grant is less than a number of bit fields of the first uplink grant.

20. A wireless communication method comprising:
receiving, by a wireless communication node from a wireless communication terminal, uplink traffic information; and
transmitting, by the wireless communication node to the wireless communication terminal, uplink transmission indications periodically in response to the uplink traffic information to allow the wireless communication terminal to transmit an uplink message periodically according to the uplink transmission indications.

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. A wireless communication terminal, comprising:
a communication unit; and
a processor configured to: transmit, to a wireless communication node, uplink traffic information; receive, from the wireless communication node, uplink transmission indications periodically in response to the uplink traffic information; and transmit, to the wireless communication node, an uplink message periodically according to the uplink transmission indications.

37. (canceled)

38. A wireless communication node, comprising:
a communication unit; and
a processor configured to: receive, from a wireless communication terminal, uplink traffic information; and transmit, to the wireless communication terminalnode, uplink transmission indications periodically in response to the uplink traffic information to allow the wireless communication terminal to transmit an uplink message periodically according to the uplink transmission indications.

39. (canceled)

40. A computer program product comprising a computer-readable program medium code stored thereupon, the code, when executed by a processor, causing the processor to implement a wireless communication method as claimed in claim 1.
